(19) United States
(12) Patent Application Publication
(10) Pub. No.: US 2024/0161505 A1
(43) Pub. Date: May 16, 2024

(54) BEHAVIOR IMAGE SENSOR SYSTEM

(71) Applicant: Guangzhou Tyrafos Semiconductor Technologies Co., Ltd., Guangzhou (CN)

(72) Inventors: Hsu-Wen Fu, Kaohsiung City (TW); Jun-Wen Chung, Tainan City (TW); Chia-Hao Chang, Taoyuan City (TW)

(21) Appl. No.: 18/231,867

(22) Filed: Aug. 9, 2023

(30) Foreign Application Priority Data
Nov. 11, 2022 (TW) 111143194

(51) Int. Cl. G06V 20/52; G06T 7/292; G06V 10/74; G06V 10/764; G08G 1/16; H04N 7/18

(52) U.S. Cl. CPC G06V 20/52; G06T 7/292; G06V 10/74; G06V 10/764; G08G 1/166; H04N 7/181; B60Q 5/00; G06T 2207/20081; G06T 2207/30232

(57) ABSTRACT

Provided is behavior image sensor system, including a first image capturing unit and a control unit. The first image capturing unit is used for capturing a moving image. The control unit is electrically connected to the first image capturing unit, receives the moving image, and calculates a moving track of a moving object in the moving image, thereby determining whether the moving track of the moving object conforms to a particularly dangerous behavior pattern. As such, the behavior image sensor system does not need to capture a static image of a static object completely and determine a behavior pattern of the static object, so that the behavior image sensor system may reduce the quantity of data a lot and is suitable for all kinds of environment.

### CROSS-REFERENCE TO RELATED APPLICATION

This application claims the priority of Taiwanese patent application No. 111143194, filed on Nov. 11, 2022, which is incorporated herewith by reference.

### BACKGROUND OF THE INVENTION

### 1. Field of the Invention

The present invention relates generally to a behavior image sensor system.

### 2. The Prior Arts

The conventional remote monitoring system uses a camera to take pictures of a specific area, and the user can see the following events from the monitoring screen: first, someone or a wild animal invades a specific area; second, the wild animal is a dangerous animal; third, someone punches, kicks, or fights each other; fourth, someone does not have the authority to enter the specific area. Once the above events occur, the user can immediately take contingency measures.

However, the cameras of the conventional remote monitoring system all record images continuously for a long time, and the amount of video data is quite huge.

Furthermore, the user's eyes must be fixed on the monitoring screen all the time, so as to ensure that no event is missed, which increases the physical and mental burden of the user. The user will inevitably be distracted, or need to leave the post temporarily for some reason. These factors may cause the user not to notice the above-mentioned event, miss the good opportunity to take contingency measures, and increase the probability of accidents.

In addition, there is currently no device on the market to monitor whether the driver makes dangerous actions. Once the driver makes dangerous actions such as dozing off, sliding the mobile phone or bowing his head, which might cause a car accident and is quite dangerous.

### SUMMARY OF THE INVENTION

A primary objective of the present invention is to provide a behavioral image sensor system that can effectively reduce the amount of data processing and is applicable to any environment.

Another objective of the present invention is to provide a behavior image sensor system that can reduce the probability of accidents.

In order to achieve the aforementioned objectives, the present invention provides a behavioral image sensor system, including a first image capturing unit, for capturing a moving image; and a control unit, electrically connected to the first image capturing unit, receiving the moving image, and calculating a moving track of a moving object in the moving image to determine whether the moving track of the moving object conforming to a specific dangerous behavior pattern.

In a preferred embodiment, the behavior image sensor system further includes a warning unit, and the control unit is electrically connected to the warning unit; wherein, when the control unit determines that the moving track of the moving object conforms to a specific dangerous behavior pattern, the control unit controls the warning unit to send out a warning signal.

In a preferred embodiment, the behavior image sensor system further includes a second image capturing unit, the control unit is electrically connected to the second image capturing unit; wherein, when the control unit determines that the moving track of the moving object conforms to the specific dangerous behavior pattern, the control unit activates the second image capturing unit for capturing general images, the control unit receives the general images, and calculates an appearance of the moving object in the general image to determine whether the appearance of the moving object conforms to a specific category.

In a preferred embodiment, the control unit further includes an image database and a comparison program, the control unit compares with the image database through the comparison program and calculates the appearance of the moving object in the general image to determine whether the appearance of the moving object conforms to the specific category.

In a preferred embodiment, the comparison program further includes a deep learning algorithm, the deep learning algorithm calculates the appearance of the moving object to determine whether the appearance of the moving object conforms to the specific category.

In a preferred embodiment, the behavior image sensor system further includes a warning unit, and the control unit is electrically connected to the warning unit; wherein, when the control unit determines that the appearance of the moving object conforms to the specific category, the control unit controls the warning unit to send out a warning signal.

In a preferred embodiment, the behavior image sensor system further includes a distance sensing unit, and the control unit is electrically connected to the distance sensing unit; wherein, when the control unit determines the moving track of the moving object conforms to the specific dangerous behavior pattern, or when the control unit determines that the appearance of the moving object conforms to the specific category, the control unit activates the distance sensing unit for sensing the moving object, receives the distance data of the moving object, and determines whether the distance of the moving object is less than a preset value.

In a preferred embodiment, the behavior image sensor system further includes a warning unit, the control unit is electrically connected to the warning unit; wherein, when the control unit determines that the distance of the moving object is less than the preset value, the control unit controls the warning unit to send out a warning signal.

In a preferred embodiment, the warning signal at least includes sound, ultrasonic wave, strong light, voice, vibration or text, and is used to drive away the moving object or notify the user.

In a preferred embodiment, the warning unit at least includes one of an outdoor siren, a voice player, a vibrator, and a notification program, the outdoor siren is arranged outdoors, and the outdoor siren produces the warning signal includes at least one of sound, ultrasonic wave, and strong light; the voice player is provided on a vehicle, and the warning signal generated by the voice player is a voice; the vibrator is provided on a steering wheel, the warning signal generated by the vibrator is a vibration; the notification program is provided in one of a vehicle computer, a remote monitoring system, and a portable electronic device, the warning signal generated by the notification program includes at least one of text and voice, and the notification program pushes and broadcasts the warning signal through one of the vehicle computer, the remote monitoring system, and the portable electronic device.

The effect of the present invention is that the behavioral image sensor system of the present invention can determine the behavioral pattern of a moving object by means of a moving image, without the need to capture a static image of a static object or determine the behavioral pattern of a static object. The amount of data processing is much reduced, and it is suitable for any environment.

Moreover, after the behavioral image sensor system of the present invention determines the behavior pattern of the moving object, it further determines the category of the moving object through the general image, and does not need to capture the static image of the static object at all, nor does it need to determine the type of static object, thereby the amount of data processing is much reduced.

In addition, the behavioral image sensor system of the present invention further calculates the distance of the moving object after determining the behavior pattern or category of the moving object, and determines whether the distance of the moving object is less than a preset value, and does not need to calculate the distance of the static object at all. There is no need to determine whether the distance of the static object is less than the preset value, and the amount of data processing is greatly reduced.

In addition, the control unit can control the warning unit to send a warning signal to drive away the moving object or notify the user according to the situation, so as to reduce the probability of accidents.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic structural view of the behavioral image sensor system of the present invention.

FIG. 2 is a flowchart of a first embodiment of the behavioral image sensor system of the present invention.

FIG. 3 is a flowchart of a second embodiment of the behavioral image sensor system of the present invention.

FIG. 4 is a flowchart of a third embodiment of the behavioral image sensor system of the present invention.

FIG. 5 is a flowchart of a fourth embodiment of the behavioral image sensor system of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

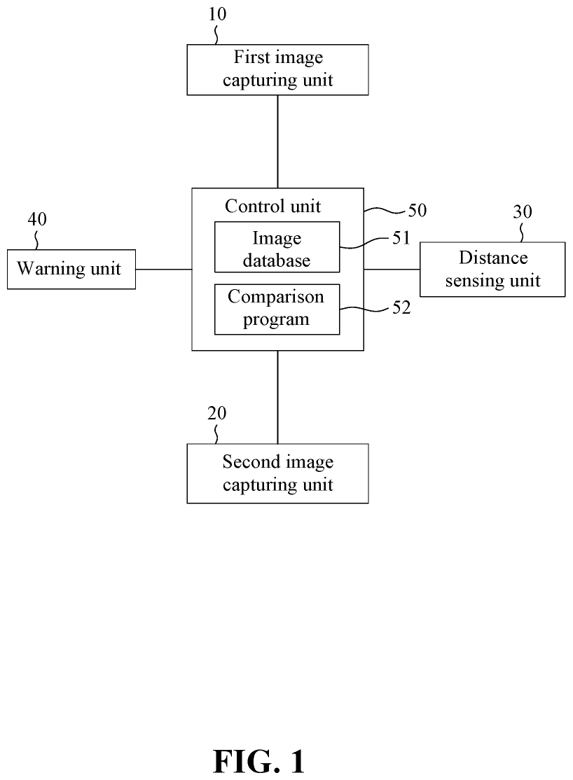

FIG. 1 is a schematic structural view of the behavioral image sensor system of the present invention. As shown in FIG. 1, the present invention provides a behavioral image sensor system, including a first image capturing unit 10, a second image capturing unit 20, a distance sensing unit 30, a warning unit 40, and a control unit 50. The control unit 50 is electrically connected to the first image capturing unit 10, the second image capturing unit 20, the distance sensing unit 30, and the warning unit 40. The control unit 50 further includes an image database 51 and a comparison program 52, and the comparison program 52 further includes a deep learning algorithm.

The first image capturing unit 10 is a dynamic vision sensor ((DVS), and the dynamic vision sensor records information in units of events. Specifically, when the object is moving, the light intensity in the environment will change, and the dynamic vision sensor can detect and record the change in the light intensity in the environment. Therefore, the first image capturing unit 10 is actually detecting the change of light intensity when the object in the environment is moving. The object that is moving can be defined as a moving object, and the change of light intensity in the environment can be defined as a moving image.

The second image capturing unit 20 is a general image sensor (for example, RGB CMOS image sensor), and the general image sensor records images in units of frames, and the image content can be color pixels or black and white pixels. Therefore, the second image capturing unit 20 essentially records the image of the moving object with surrounding environment and recognizes the appearance of the moving object in the image.

The distance sensing unit 30 is an optical radar sensor (LiDAR Sensor), an indirect time-of-flight sensor (iToF Sensor) or a direct time-of-flight sensor (dToF Sensor). Therefore, the distance sensing unit 30 of the above type essentially detects the distance of the moving object by technologies such as optical radar, indirect time-of-flight or direct time-of-flight.

The following will illustrate the operation of the behavioral image sensor system of the present invention through a plurality of embodiments.

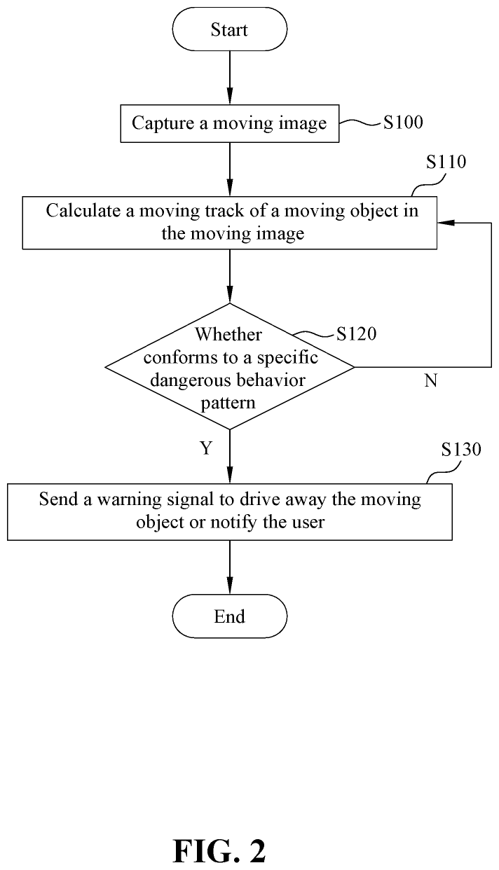

FIG. 2 is a flowchart of the first embodiment of the behavioral image sensor system of the present invention. As shown in FIGS. 1 and 2, the first embodiment includes the following steps: Step S100, when a moving object (not shown) enters the image capturing range of the first image capturing unit 10, the first image capturing unit 10 captures a moving image; Step S110, the control unit 50 receives the moving image and calculates a moving track of a moving object in the moving image; Step S120, the control unit 50 determines whether the moving track of the moving object conforms to a specific dangerous behavior pattern; and Step S130, when the control unit 50 determines that the moving track of the moving object conforms to a specific dangerous behavior pattern, the control unit 50 controls the warning unit 40 to send a warning signal, and the warning signal is used to drive away the moving object or notify the user; when the control unit 50 determines the moving track of the moving object does not conform to the specific dangerous behavior pattern, return to step S110.

An exemplar will be cited below to illustrate how the first embodiment monitors whether the driver is making dangerous actions in the vehicle. In this case, the warning unit 40 is a voice player or a notification program. The voice player is disposed on the vehicle, and the notification program is installed on the vehicle computer or portable electronic devices such as smart phones and tablet computers. The vehicle is a specific venue, and the dangerous action is a specific dangerous behavior pattern.

Step S100, when the driver enters the image capturing range of the first image capturing unit 10, the first image capturing unit 10 captures images (moving images) of eyeballs, hands, or head movements; step S110, the control unit 50 receives the image of eyeball, hand, or head movement and calculates the moving track of the eyeball, hand, or head (moving object) in the moving image of eyeball, hand or head; step S120, the control unit 50 determine whether the movement moving track of the eyeball, hand or head conforms to a specific dangerous behavior pattern as “dangerous action”, such as dozing off, sliding the phone or bowing the head; and step S130, when the control unit 50 determines that the moving track of the eyeball, hand, or head conforms to the specific dangerous behavior pattern as “dangerous action”, the control unit 50 controls the voice player (warning unit 40) to send out similar voices (warning signals) such as “you are in a dangerous driving state” or controls the notification program (warning unit 40) through the car computer or portable electronic device to push and broadcast similar voices (warning signals) such as “You are in a dangerous driving state” to achieve the purpose of notifying the driver. After receiving the notification, the driver immediately wakes up, puts down the mobile phone or looks up to avoid a car accident; when the control unit 50 determines that the moving track of the eyeballs, hands, or head does not conform to a specific dangerous behavior pattern as a “dangerous action”, such as eye staring ahead, holding the steering wheel with hands, or raising the head, return to step S110.

An exemplar will be cited below to illustrate how the first embodiment monitors whether the building is broken into. In this case, the warning unit 40 includes at least one buzzer, at least one warning light, and a notification program, the buzzer and warning light are installed outdoors, and the notification program is installed in a remote monitoring system or smart phone, tablet computer, or portable electronic devices. A building is a specific venue, and breaking through an empty door is a specific dangerous behavior pattern.

Step S100, when someone enters the image capturing range of the first image capturing unit 10, the first image capturing unit 10 captures an image (moving image) of someone's actions; step 110, the control unit 50 receives an image of someone's actions and calculates the moving track of someone (moving object) in the image of someone's actions; step S120, the control unit 50 determines whether the moving track of someone's actions conforms to a specific dangerous behavior pattern as “breaking the door”; and step S130, when the control unit 50 judges that someone's moving track conforms to a specific dangerous behavior pattern as “breaking the door”, for example, someone climbing a wall to enter or prying open the door lock, etc., the control unit 50 controls the buzzer (warning unit 40) to make a loud sound (warning signal) or control the warning light (warning unit 40) to continuously flash strong light (warning signal), someone will be frightened by the sudden sound or strong light, which achieves the purpose of driving away someone; at the same time the control unit 50 controls the notification program (warning unit 40) to push and broadcast similar text or voice (warning signal) such as “someone breaks into the empty door”, and the homeowner can learn from the remote monitoring system or portable electronic device that “someone breaks into the empty door” and other events occur, and emergency response measures can be taken immediately; when the control unit 50 determines that someone's moving track does not meet the specific dangerous behavior pattern as “breaking the door”, such as someone passing by the door, knocking on the door or ringing the doorbell, etc., return to step S110.

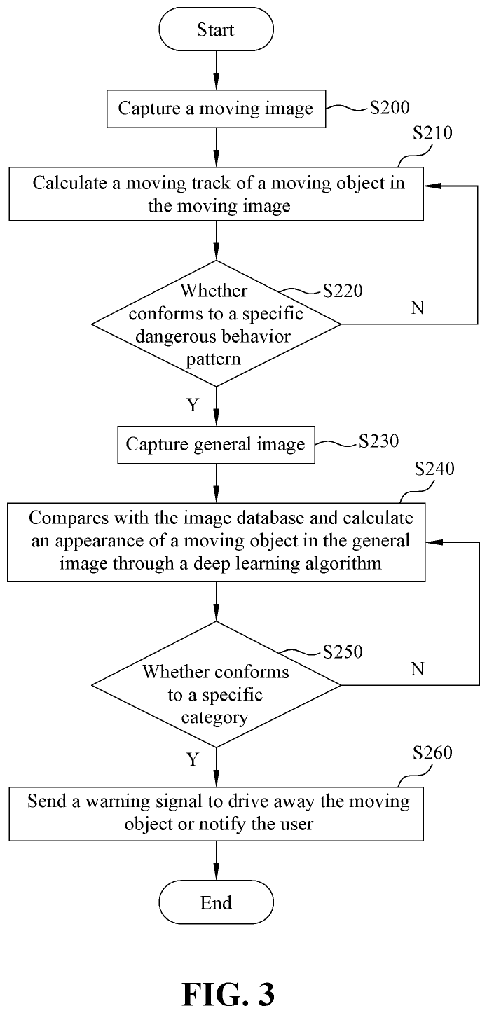

FIG. 3 is a flowchart of a second embodiment of the behavioral image sensor system of the present invention. As shown in FIG. 1 and FIG. 3, the steps S200-S220 of the second embodiment are exactly the same as the steps S100-S120 of the first embodiment; the second embodiment further includes the following steps: Step S230, when the control unit 50 determines that the moving track of the moving object conforms to the specific dangerous behavior pattern, the control unit 50 starts the second image capturing unit 20, and the second image capturing unit 20 captures the general image; when the control unit 50 determines that the moving track of the moving object does not conform to the specific dangerous behavior pattern, return to step S210; step S240, the control unit 50 receives the general image, compares with the image database 51 through the comparison program 52, and calculates an appearance of a moving object in the general image through a deep learning algorithm; step S250, the control unit 50 determines whether the appearance of the moving object conforms to a specific category; step S260, when the control unit 50 determines that the appearance of the moving object conforms to a specific category, the control unit 50 controls the warning unit 40 to send a warning signal, and the warning signal is used to drive away the moving object or notify the user; when the control unit 50 determines that the appearance of the moving object does not meet the specific category, return to step S240.

An exemplar will be cited below to illustrate how the second embodiment monitors whether wild animals invading the buildings in sparsely populated areas are dangerous animals. In this case, the warning unit 40 includes at least one buzzer, at least one ultrasonic repeller, at least one warning light, and a notification program, the buzzer, the ultrasonic repeller, and the warning light are installed outdoors, and the notification program is installed at the remote monitoring systems or portable electronic devices such as smart phones and tablet computers, buildings are specific venues, and intrusion into buildings is a specific dangerous behavior pattern.

Step S200, when the wild animal enters the image capturing range of the first image capturing unit 10, the first image capturing unit 10 captures an image (moving image) of the wild animal's action; step S210, the control unit 50 receives an image of a wild animal's action and calculates the moving track of the wild animal (moving object) in the image of the wild animal's action; step S220, the control unit 50 determines whether the moving track of the wild animal conforms to a specific dangerous behavior pattern of “invading a building”; step S230, when the control unit 50 determines that the moving track of the wild animal conforms to the specific dangerous behavior pattern as “invasion of the building”, for example, the wild animal walks towards the building, the control unit 50 starts the second image capturing unit 20, and the second image capturing unit 20 captures images of wild animals and their surroundings (ordinary images); when the control unit 50 determines that the moving track of a wild animal does not conform to a specific dangerous behavior pattern as “invading a building”, for example, a wild animal is gradually moving away from the building, return to step S210; step S240, the control unit 50 receives the images of wild animals and their surroundings, compares with the image database 51 through the comparison program 52, and calculates the image of the appearance of wild animals and their surroundings through a deep learning algorithm; step S250, the control unit 50 determines whether the appearance of wild animals conforms to a specific category as “dangerous animals”, such as lions, tigers, leopards, bears, wolves, wild dogs, badgers, foxes, mink, raccoons, wild boars, rats, birds, bats, rodents, etc.; step S260, when the control unit 50 determines that the appearance of wild animals conforms to a specific category as “dangerous animals”, the control unit 50 controls the buzzer (warning unit 40) to sound loudly (warning signal) or control the ultrasonic repeller (warning unit 40) to generate ultrasonic waves (warning signal) or control the warning light (warning unit 40) to continuously flash strong light (warning signal), wild animals will be frightened by sudden sound or strong light, or receive the repelling ultrasonic waves, wild animals will be scared away, which achieves the purpose of driving away dangerous animals; at the same time, the control unit 50 controls the notification program (warning unit 40) to push and broadcast “dangerous animals invading buildings” and similar text or voice (warning signal), the homeowner can learn from the remote monitoring system or portable electronic device that “dangerous animals have invaded the building” and other events, and can immediately take emergency response measures; when the control unit 50 determines that the appearance of wild animals does not meet the specific category of “dangerous animals”, such as omnivorous or herbivorous animals such as humans, sheep, deer, and rabbits, go back to step S240.

It is worth mentioning that ultrasonic waves with a frequency of 13.5 kHz can drive away animals such as mice, dogs, foxes, and minks, and ultrasonic waves with a frequency of 19.5 to 24.5 kHz can drive away animals such as cats, raccoons, badgers, and bears; the ultrasonic waves of 24.5 to 45.5 kHz can drive away bats, birds, rodents and other animals, and strong flashes can drive away raccoons, wild boars, minks and other animals. In fact, ultrasonic waves with a frequency of 13.5-45.5 kHz can drive away all the wild animals listed above, and with strong flashes, all animals can be driven away.

An exemplar will be cited below to illustrate how the second embodiment monitors whether prisoners or prison wardens who are active in areas such as activity grounds, restaurants, and factories in prisons make violent acts. In this case, the warning unit 40 is a notification program, which is installed in the remote monitoring system. Areas such as activity grounds, restaurants, and factories in prisons are specific venues, and violent behavior is a specific dangerous behavior pattern.

Step S200, when someone enters the image capturing range of the first image capturing unit 10, the first image capturing unit 10 captures an image (moving image) of someone's actions; step S210, the control unit 50 receives an image of someone's action and calculates the moving track of a person (moving object) in the image of someone's action; step S220, the control unit 50 determines whether the moving track of someone's action conforms to a specific dangerous behavior pattern as “violent behavior”; step S230, when the control unit 50 determines that someone's moving track conforms to a specific dangerous behavior pattern as “violent behavior”, such as punching, kicking, and fighting each other, the control unit 50 starts the second image capturing unit 20, and the second image capturing unit 20 captures images of a person and their surroundings (general images); when the control unit 50 determines that a person's moving track does not meet a specific dangerous behavior pattern as “violent behavior”, such as normal behavior such as walking, sitting, sitting, etc., return to step S210; step S240, the control unit 50 receives the image of a person and his surrounding environment, compares with the image database 51 through the comparison program 52, and calculates a certain value in the image of the appearance of a person and his surrounding environment through a deep learning algorithm; step S250, the control unit 50 determines whether the appearance of a certain person conforms to a specific category as “a certain prisoner or prison warden”, and the control unit 50 can further determine the name and number of a certain prisoner or a prisoner warden's name; step S260, when the control unit 50 judges that someone's appearance conforms to a specific category as “a certain prisoner or prison warden”, the control unit 50 controls the notification program (warning unit 40) to push “a certain prisoner” so that other prison wardens can learn from the texts or voices (warning signals) of the remote monitoring system that “a prisoner or prison warden has committed violent acts”, and emergency response measures can be taken immediately.

An exemplar will be cited below to illustrate how the second embodiment monitors whether someone illegally breaks into the restricted area. The restricted area refers to a special area that is not allowed to enter without permission, and only those who have obtained permission can enter, such as military restricted areas, airport restricted areas, border restricted areas, truce areas, fishing prohibited areas, and employee lounges. In this case, the warning unit 40 is a notification program installed in the remote monitoring system, the restricted area is a specific venue, and illegal entry is a specific dangerous behavior pattern.

Step S200, when someone enters the image capturing range of the first image capturing unit 10, the first image capturing unit 10 captures an image (moving image) of someone's actions; step S210, the control unit 50 receives an image of someone's action and calculates the moving track of someone (moving object) in the image of someone's action; step S220, the control unit 50 determines whether the moving track of someone's action conforms to a specific dangerous behavior pattern as “illegal intrusion”; Step S230, when the control unit 50 determines that someone's moving track conforms to a specific dangerous behavior pattern as “illegal intrusion”, for example, someone crosses the boundary of the restricted area and enters the restricted area, the control unit 50 activates the second image capturing unit 20, the second image capturing unit 20 captures an image (general image) of a person and his surroundings; when the control unit 50 determines that a person's moving track does not meet a specific dangerous behavior pattern as “illegal trespassing”, for example, a person is in a restricted area walking outside the boundaries of the restricted area and not entering the restricted area, return to step S210; step S240, the control unit 50 receives the image of a person and his surrounding environment, compares with the image database 51 through the comparison program 52, and calculates the person's appearance in the image of the person and his surrounding environment through the deep learning algorithm; step S250, the control unit 50 determines whether the person's appearance conforms to a specific category as “person without authority”; step S260, when the control unit 50 determines the person's appearance conforms to the specific category as “person without authority”, the control unit 50 controls the notification program (warning unit 40) to push and broadcast similar text or voice (warning signal) such as “someone illegally breaks into the restricted area”, and the guard can know from the remote monitoring system that “someone illegally breaks into the restricted area” and other events, and can immediately take emergency response measures; when the control unit 50 determines that someone's appearance does not meet the specific category as “person without authority”, return to step S240.

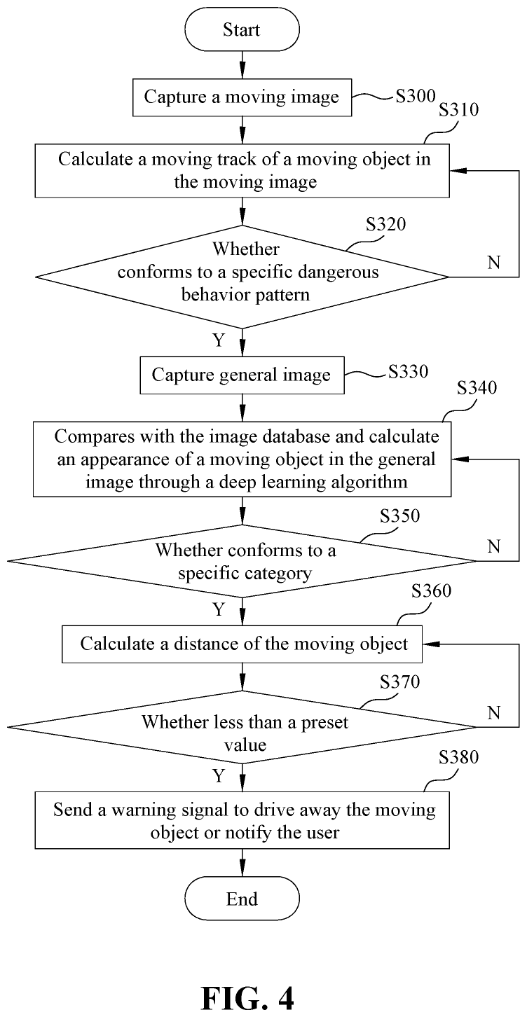

FIG. 4 is a flowchart of a third embodiment of the behavioral image sensor system of the present invention. As shown in FIG. 1 and FIG. 4, the steps S300-S350 of the third embodiment are exactly the same as the steps S200-S250 of the second embodiment, and the third embodiment further includes the following steps: Step S360, when the control unit 50 determines that the appearance of the moving object conforms to a specific category, the control unit 50 activates the distance sensing unit 30, a transmitter (not shown) of the distance sensing unit 30 emits light, and a receiver (not shown) of the distance sensing unit 30 receives light. From the light reflected by the moving object, the distance sensing unit 30 calculates a distance of the moving object according to the time difference between light emission and reception; when the control unit 50 determines that the appearance of the moving object does not meet the specific category, return to step S340; step S370, the control unit 50 receives the distance data of the moving object, and determines whether the distance of the moving object is less than a preset value; step S380, when the control unit 50 determines that the distance of the moving object is less than the preset value, the control unit 50 controls the warning unit 40 to send a warning signal, the warning signal is used to drive away the moving object or notify the user; when the control unit 50 determines that the distance of the moving object is greater than the preset value, return to step S360.

An exemplar will be cited below to illustrate how the third embodiment monitors whether wild animals that invade buildings in sparsely populated areas are dangerous animals.

Steps S300-S350 of this exemplar may refer to steps S200-S250 of the exemplar of how to monitor whether a wild animal invading a building with a large area and few people is a dangerous animal in the second embodiment. Step S360, when the control unit 50 determines that the appearance of the wild animal conforms to the specific category as “dangerous animal”, the control unit 50 activates the distance sensing unit 30, and the distance sensing unit 30 calculates the distance of the wild animal; when the appearance of the animal does not meet the specific category of “dangerous animal”, return to step S340; step S370, the control unit 50 receives the distance data of the wild animal, and determines whether the distance of the wild animal is less than a preset value; step S380, when the control unit 50 determines that the distance of the wild animal is less than the preset value, the control unit 50 controls the buzzer (warning unit 40) to sound loudly (warning signal) or controls the ultrasonic repeller (warning unit 40) to generate ultrasonic waves (warning signal) or controls the warning light (warning unit 40) flashes strong light (warning signal) constantly, and wild animals will be frightened by sudden sound or strong light, or receive the repelling ultrasonic wave, and wild animals will be scared away, achieving the purpose of driving away the dangerous animal; at the same time, the control unit 50 controls the notification program (warning unit 40) to push and broadcast similar text or voice (warning signal) such as “dangerous animals intruding the building”, and the homeowner can learn that events such as “dangerous animals intruding the buildings” have occurred, and can immediately take emergency response measures; when the control unit 50 determines that the distance of wild animals is greater than the preset value, returns to step S360.

An exemplar will be cited below to illustrate how the third embodiment monitors whether someone illegally breaks into the restricted area.

Steps S300-S350 of this exemplar may refer to steps S200-250 of the exemplar of how to monitor whether someone illegally breaks into the restricted area in the second embodiment. Step S360, when the control unit 50 determines that the appearance of a certain person conforms to the specific category as “person without authority”, the control unit 50 activates the distance sensing unit 30, and the distance sensing unit 30 calculates the distance of the certain person; step S370, the control unit 50 receives the distance data of the person, and determines whether the distance of the person is less than the preset value; step S380, when the control unit 50 determines that the distance of the person is less than the preset value, the control unit 50 controls the notification program (warning unit 40) to push an broadcast similar texts or voices (warning signals) such as “someone illegally enters the restricted area”, the guard can learn from the remote monitoring system that “someone illegally enters the restricted area” and other events, and can immediately take emergency response measures; when the control unit 50 judges that the distance of someone is greater than the preset value, return to step S360.

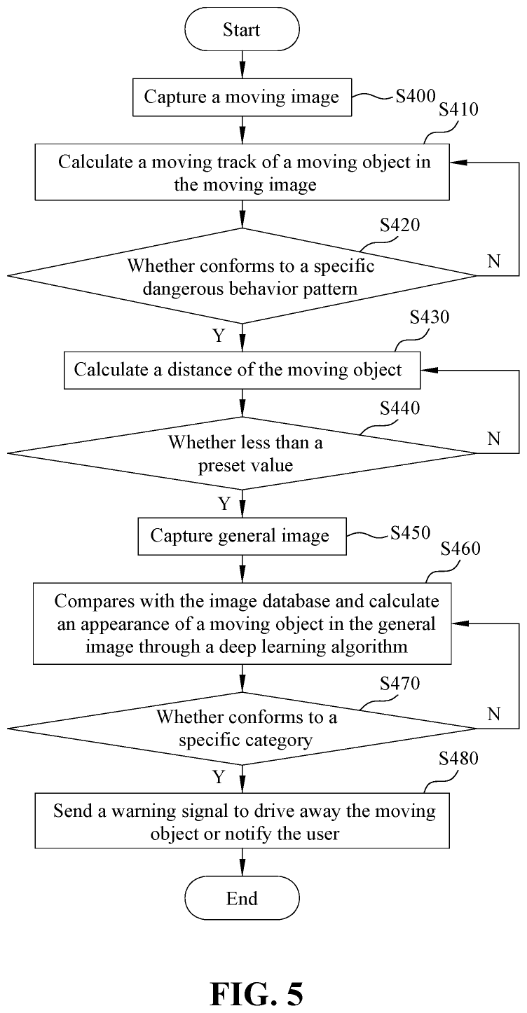

FIG. 5 is a flowchart of a fourth embodiment of the behavioral image sensor system of the present invention. As shown in FIG. 1 and FIG. 5, steps S400-S420 of the fourth embodiment are exactly the same as steps S200-S220 of the second embodiment, and the fourth embodiment further includes the following steps: Step S430, when the control unit 50 determines that the moving track of the moving object conforms to the specific dangerous behavior pattern, the control unit 50 activates the distance sensing unit 30, a transmitter (not shown) of the distance sensing unit 30 emits light, and a receiver (not shown) of the distance sensing unit 30 receives the light reflected by the moving object, and the distance sensing unit 30 calculates a distance of the moving object according to the time difference between light emission and reception; when the control unit 50 determines that moving track of the moving object does not conform to the specific dangerous behavior pattern, return to step S410; step S440, the control unit 50 receives the distance data of the moving object, and determines whether the distance of the moving object is less than a preset value; step S450, when the control unit 50 determines that the distance of the moving object is less than the preset value, the control unit 50 activates the second image capturing unit 20, the second image capturing unit 20 captures the general image; when the control unit 50 determines that the distance of the moving object is greater than the preset value, return to step S430; step S460, the control unit 50 receives the general image, compares with the image database 51 through the comparison program 52, and calculates an appearance of the moving object in the general image through the deep learning algorithm; step S470, the control unit 50 determines whether the appearance of the moving object conforms to a specific category; step S480, when the control unit 50 determines that the appearance of the moving object conforms to a specific category, the control unit 50 controls the warning unit 40 to send a warning signal, which is used to drive away the moving object or notify the user; when the control unit 50 determines that the appearance of the moving object does not meet the specific category, return to step S460.

An exemplar will be cited below to illustrate how the fourth embodiment monitors whether wild animals that invade buildings in sparsely populated areas are dangerous animals.

Steps S400-S420 of this exemplar may refer to steps S200-S220 of the exemplar of how to monitor whether a wild animal invading a building with a large area and few people is a dangerous animal in the second embodiment. Step S430, when the control unit 50 determines that the moving track of the wild animal conforms to a specific dangerous behavior pattern as “invasion of the building”, for example, the wild animal walks towards the building, the control unit 50 activates the distance sensing unit 30, and the distance sensing unit 30 calculates the distance of the wild animal; step S440, the control unit 50 receives the distance data of the wild animal, and determines whether the distance of the wild animal is less than a preset value; step S450, when the control unit 50 determines that the distance of the wild animal is less than the preset value, the control unit 50 activates the second image capturing unit 20, and the second image capturing unit 20 captures images of wild animals and their surroundings (general images); when the control unit 50 determines that the distance of the wild animals is greater than a preset value, return to step S430; step S460, the control unit 50 receives the image of the wild animal and its surrounding environment, compares with the image database 51 through the comparison program 52, and calculates the appearance of the wild animal in the image of the wild animal and its surrounding environment through a deep learning algorithm; step S470, the control unit 50 determines whether the appearance of the wild animal conforms to the specific category as “dangerous animal”; step S480, when the control unit 50 determines that the appearance of the wild animal conforms to the specific category as “dangerous animal”, the control unit 50 controls the buzzer (warning unit 40) to make a loud sound (warning signal) or controls the ultrasonic repeller (warning unit 40) to generate ultrasonic waves (warning signal) or controls the warning light (warning unit 40) to continuously flash strong light (warning signal), so that wild animals will be frightened by the sudden sound or strong light, or receive the repelling ultrasonic waves, and the wild animals will be scared away, so as to achieve the purpose of driving away dangerous animals; at the same time, the control unit 50 controls the notification program (warning unit 40) to push and broadcast similar text or voice (warning signal) such as “dangerous animals intruding the building”, and the homeowner can learn from the remote monitoring system or portable electronic device the events such as “dangerous animals intruding the buildings” occur, and emergency response measures can be taken immediately; when the control unit 50 determines that the appearance of the wild object does not conform to the specific category as “dangerous animal”, it returns to step S460.

An exemplar will be cited below to illustrate how the fourth embodiment monitors whether someone illegally breaks into the restricted area.

Steps S400-S420 in this exemplar may refer to steps S200-S220 in the exemplar of how to monitor whether someone illegally breaks into the restricted area in the second embodiment. Step S430, when the control unit 50 determines that someone's moving track conforms to a specific dangerous behavior pattern as “illegal intrusion”, the control unit 50 activates the distance sensing unit 30, and the distance sensing unit 30 calculates the distance of the person; step S440, the control unit 50 receives the distance data of the person, and determines whether the distance of the person is smaller than the preset value; step S450, when the control unit 50 determines that the distance of the person is smaller than the preset value, the control unit 50 activates the second image capturing unit 20, and the second image capturing unit 20 captures an image of a person and his surroundings (general image); when the control unit 50 determines that the distance of a person is greater than a preset value, return to step S430; step S460, the control unit 50 receives the image of a certain person and its surrounding environment, compares with the image database 51 through the comparison program 52, and calculates the appearance of the certain person in the image of the certain person and its surrounding environment through a deep learning algorithm; step S470, the control unit 50 determines whether the person's appearance conforms to the specific category as “person without authority”; step S480, when the control unit 50 determines that the person's appearance conforms to the specific category as “person without authority”, the control unit 50 controls the notification program (warning unit 40) to push and broadcast similar text or voice (warning signal) such as “someone illegally enters the restricted area”, and the guards can learn from the remote monitoring system that “someone illegally enters the restricted area” and other events, and can immediately take emergency response measures; when the control unit 50. determines that the person's appearance does not meet the specific category as “person without authority”, return to step S460.

The respiration measurement is to calculate the respiration rate or detect whether there is respiration according to the rise and fall of the chest by taking images of the upper body of the subject (i.e., a moving object). According to the present invention, the image capturing range of the first image capturing unit 10 or the second image capturing unit 20 is captured to generate a sensing image, and a communication module (not shown) and other related components are used to remind the user whether the subject has apnea; in detail, the subject is in the image capturing range of the first image capturing unit 10 or the second image capturing unit 20 of the present invention, and the first image capturing unit 10 or the second image capturing unit 20 can use the image capturing function to determine whether the chest of the subject continues to rise and fall through the control unit 50. If the subject's chest has stopped rising and falling during monitoring, the warning unit 40 pushes and broadcasts “the subject's chest stops rising and falling” or similar text or voice (warning signal), to notify that the dangerous situation of the subject's breathing abort may occur, and the user can learn from the remote monitoring system that “the subject's chest stops rising and falling” and other events have occurred, and emergency response measures can be taken immediately.

Object detection technology is a computer technology related to computer vision and image processing, which is used to detect a certain category in images and videos, such as humans, animals, buildings or vehicles. The research fields of object detection include, for example, face detection and pedestrian detection. Object detection has applications in many fields of computer vision, including image retrieval and video surveillance. The first image capturing unit 10 or the second image capturing unit 20 of the present invention can use object detection technology to detect car drivers, pedestrians, animals in prisons and the environment in the image frame. Object detection methods are generally classified as neural network-based methods or non-neural methods. For non-neural methods, it is necessary to first define features using one of the following methods, and then use techniques such as support vector machines (SVM) for classification. Neural techniques, on the other hand, enable object detection without well-defined features and are usually based on Convolutional Neural Networks (CNNs). Non-neural methods, such as Viola-Jones object detection framework based on Haar features, scale-invariant feature transform (SIFT), histogram of oriented gradients (HOG) features, etc., but not limited thereto; neural methods, such as Region Proposals (R-CNN), Single Shot Multibox Detector (SSD), You Only Look Once (YOLO), Single-Shot Refinement Neural Network for Object Detection (RefineDet)), Retina-Net, Deformable convolutional networks, etc., but not limited thereto.

Behavior recognition, motion recognition or body movement recognition is to use image capturing and image processing related computer technology to recognize animal movements. Due to its multifaceted nature, different fields may refer to behavior recognition as plan recognition, target recognition, intention recognition, position estimation, etc. Types of behavior recognition, such as sensor-based single-user activity recognition, levels of sensor-based activity recognition, sensor-based, multi-user activity recognition and other methods; behavior recognition methods, such as activity recognition through logic and reasoning, activities through probabilistic reasoning, data mining-based approach to activity recognition, GPS-based activity recognition, but not limited thereto. The first image capturing unit 10 of the present invention uses behavior recognition technology to detect specific dangerous behavior patterns of moving objects in the image screen, such as dangerous actions of drivers, someone breaking through empty doors or illegally entering restricted areas, wild animals intruding into buildings, violence by prison inmates or wardens, and so on.

In summary, the behavioral image sensor system of the present invention can determine the behavioral pattern of a moving object through moving images, without the need to capture static images of static objects or determine the behavioral pattern of static objects. The amount of processing is much reduced, and it is suitable for any environment.

Moreover, after the behavioral image sensor system of the present invention determines the behavior pattern of the moving object, it further determines the category of the moving object from the general image, and does not need to capture the static image of the static object at all, nor does it need to determine the type of the static object, the amount of data processing is much reduced.

Moreover, the behavioral image sensor system of the present invention further calculates the distance of the moving object after determining the behavior pattern or category of the moving object, and determines whether the distance of the moving object is less than a preset value, and does not need to calculate the distance of the static object at all. There is no need to determine whether the distance of the static object is less than the preset value, and the amount of data processing is greatly reduced.

Moreover, the control unit 50 can control the warning unit 40 to send a warning signal to drive away the moving object or notify the user according to the situation, so as to reduce the probability of accidents.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A behavioral image sensor system, comprising:
a first image capturing unit, for capturing a moving image; and
a control unit, electrically connected to the first image capturing unit, receiving the moving image, and calculating a moving track of a moving object in the moving image to determine whether the moving track of the moving object conforming to a specific dangerous behavior pattern.

2. The behavioral image sensor system according to claim 1, further comprising a warning unit, and the control unit being electrically connected to the warning unit; wherein, when the control unit determining that the moving track of the moving object meeting a specific dangerous behavior pattern, the control unit controlling the warning unit to send out a warning signal.

3. The behavioral image sensor system according to claim 1, further comprising a second image capturing unit, the control unit being electrically connected to the second image capturing unit; wherein, when the control unit determining that the moving track of the moving object conforming to the specific dangerous behavior pattern, the control unit activating the second image capturing unit for capturing general images, the control unit receiving the general images, and calculating an appearance of the moving object in the general image to determine whether the appearance of the moving object conforming to a specific category.

4. The behavioral image sensor system according to claim 3, wherein the control unit further includes an image database and a comparison program, the control unit compares with the image database through the comparison program and calculates the appearance of the moving object in the general image to determine whether the appearance of the moving object conforms to the specific category.

5. The behavioral image sensor system according to claim 4, wherein the comparison program further includes a deep learning algorithm, the deep learning algorithm calculates the appearance of the moving object to determine whether the appearance of the moving object conforms to the specific category.

6. The behavioral image sensor system according to claim 3, further comprising a warning unit, and the control unit being electrically connected to the warning unit; wherein, when the control unit determining that the appearance of the moving object conforms to the specific category, the control unit controlling the warning unit to send out a warning signal.

7. The behavioral image sensor system according to claim 3, further comprising a distance sensing unit, and the control unit being electrically connected to the distance sensing unit; wherein, when the control unit determining the moving track of the moving object conforming to the specific dangerous behavior pattern, or when the control unit determining that the appearance of the moving object conforming to the specific category, the control unit activating the distance sensing unit for sensing the moving object, receiving the distance data of the moving object, and determining whether the distance of the moving object being less than a preset value.

8. The behavioral image sensor system according to claim 7, further comprising a warning unit, the control unit being electrically connected to the warning unit;
wherein, when the control unit determining that the distance of the moving object being less than the preset value, the control unit controlling the warning unit to send out a warning signal.

9. The behavioral image sensor system according to claim 2, wherein the warning signal at least includes sound, ultrasonic wave, strong light, voice, vibration or text, and is used to drive away the moving object or notify a user.

10. The behavioral image sensor system according to claim 9, wherein the warning unit at least includes one of an outdoor siren, a voice player, a vibrator, and a notification program, the outdoor siren is arranged outdoors, and the outdoor siren produces the warning signal includes at least one of sound, ultrasonic wave, and strong light; the voice player is provided on a vehicle, and the warning signal generated by the voice player is a voice; the vibrator is provided on a steering wheel, the warning signal generated by the vibrator is a vibration; the notification program is provided in one of a vehicle computer, a remote monitoring system, and a portable electronic device, the warning signal generated by the notification program includes at least one of text and voice, and the notification program pushes and broadcasts the warning signal through one of the vehicle computer, the remote monitoring system, and the portable electronic device.
